(19) United States
(12) Patent Application Publication
(10) Pub. No.: US 2026/0249692 A1
(43) Pub. Date: Aug. 27, 2026

(54) DRIVING BEHAVIOR WARNING SYSTEM AND DRIVING BEHAVIOR WARNING METHOD

(71) Applicant: Coretronic Corporation, Hsin-Chu (TW)

(72) Inventors: Hsin Huang, Hsin-Chu (TW); Ping-Yen Chen, Hsin-Chu (TW); Bo-Chih Pan, Hsin-Chu (TW); Chin-Hsiang Hsu, Hsin-Chu (TW)

(73) Assignee: Coretronic Corporation, Hsin-Chu (TW)

(21) Appl. No.: 19/547,643

(22) Filed: Feb. 23, 2026

(30) Foreign Application Priority Data
Feb. 24, 2025 (CN) 202510201420.4

(51) Int. Cl. B60K 35/28; B60K 35/22; B60K 35/65; B60K 35/81

(52) U.S. Cl. CPC B60K 35/28; B60K 35/22; B60K 35/654; B60K 35/81; B60K 2360/178; B60K 2360/21

(57) ABSTRACT

A driving behavior warning system and a driving behavior warning method are provided. The driving behavior warning system includes a driving behavior detection unit, an electrically controllable viewing angle display unit and a control unit. The driving behavior detection unit detects behavior information of a driver. The electrically controllable viewing angle display unit provides a display beam, and has a narrow viewing angle mode and a wide viewing angle mode, wherein a light emitting viewing angle range of the display beam in the narrow viewing angle mode is smaller than that in the wide viewing angle mode. When the behavior posture is an unconfirmed behavior and the vehicle driving state is a moving state, the control unit controls at least a portion of the electrically controllable viewing angle display unit to continuously switch between the narrow viewing angle mode and the wide viewing angle mode.

### CROSS-REFERENCE TO RELATED APPLICATION

This application claims the priority benefit of China application serial no. 202510201420.4, filed on February 24, 2025. The entirety of the above-mentioned patent application is hereby incorporated by reference herein and made a part of this specification.

### BACKGROUND

### Technical Field

The disclosure relates to a warning system and a warning method, and in particular relates to a driving behavior warning system and a driving behavior warning method.

### Description of Related Art

With the advancement of technology, an increasing number of vehicles are equipped with advanced driver assistance systems (ADAS). These systems not only monitor the surrounding and interior environment of the vehicle but also automatically adjust speed, braking, and direction to mitigate accident risks.

Furthermore, the fatigue driving warning system (FDWS) is a type of advanced driver assistance system, which, upon determining that the driver is in a state of fatigue driving, issues a warning to notify the driver. Common warning methods include sound alarms, visual warnings or vibration prompts. Visual warnings mainly provide flickering warning icons or output warning message to remind the driver to take a rest. However, most of the current fatigue driving warning systems predominantly utilize warning lights or steering wheel vibrations as warning methods to notify drivers, but the effectiveness of these warnings in adequately warning drivers still requires improvement.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one of, or portions of, or all of the above objectives or other objectives, a driving behavior warning system is provided in an embodiment of the disclosure. The driving behavior warning system includes a driving behavior detection unit, an electrically controllable viewing angle display unit and a control unit. The driving behavior detection unit is configured to detect behavior information of a driver. The electrically controllable viewing angle display unit is configured to provide a display beam and has a narrow viewing angle mode and a wide viewing angle mode, wherein a light emitting viewing angle range of the display beam in the narrow viewing angle mode is smaller than a light emitting viewing angle range of the display beam in the wide viewing angle mode. The control unit is coupled to the driving behavior detection unit and the electrically controllable viewing angle display unit. The control unit determines behavior posture of the driver based on the behavior information. The behavior posture includes a normal behavior and an unconfirmed behavior. The control unit controls a display mode of the electrically controllable viewing angle display unit according to a vehicle driving state and the behavior posture, wherein the vehicle driving state includes a moving state and a stationary state. When the behavior posture is the unconfirmed behavior and the vehicle driving state is the moving state, the control unit controls at least a portion of the electrically controllable viewing angle display unit to continuously switch between the narrow viewing angle mode and the wide viewing angle mode.

In order to achieve one of, or portions of, or all of the above objectives or other objectives, a driving behavior warning method is provided in an embodiment of the disclosure, including the following operation. Behavior information of a driver is detected. Behavior posture of the driver is determined based on the behavior information. The behavior posture includes a normal behavior and an unconfirmed behavior. A display mode of the electrically controllable viewing angle display unit is controlled according to a vehicle driving state and the behavior posture, wherein the vehicle driving state includes a moving state and a stationary state. When the behavior posture is the unconfirmed behavior and the vehicle driving state is the moving state, at least a portion of the electrically controllable viewing angle display unit is controlled to continuously switch between a narrow viewing angle mode and a wide viewing angle mode. A light emitting viewing angle range of a display beam in a narrow viewing angle mode is smaller than a light emitting viewing angle range of the display beam in a wide viewing angle mode.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

FIG. 1A is a block diagram of a driving behavior warning system according to an embodiment of the present disclosure.

FIG. 1B is a front-view schematic diagram of a display surface of the electrically controllable viewing angle display unit of FIG. 1A.

FIG. 1C is a cross-sectional schematic diagram of the electrically controllable viewing angle display unit of an embodiment of FIG. 1A.

FIG. 2A is a cross-sectional schematic diagram of an electrically controllable viewing angle display unit according to another embodiment of the present disclosure.

FIGS. 2B and 2C are schematic diagrams showing the configuration relationship of the alignment direction of the alignment layer, the axial direction of the absorption axis of the polarizer, and the axial direction of the slow axis of the half wave plate of FIG. 2A.

FIG. 2D is a curve chart showing the brightness versus viewing angle of the electrically controllable viewing angle display unit of FIG. 2A when operating in different display modes.

FIG. 3A is a flowchart of a driving behavior warning method according to an embodiment of the present disclosure.

FIG. 3B is a flowchart of a determination control step of the driving behavior warning method of FIG. 3A.

FIG. 3C is a determination flowchart of another determination control step of the driving behavior warning method of FIG. 3A.

FIG. 4 is a cross-sectional schematic diagram of an electrically controllable viewing angle display unit according to another embodiment of the present disclosure.

FIGS. 5A and 5B are schematic diagrams showing the configuration relationship of the alignment direction of the alignment layer and the axial direction of the absorption axis of the polarizer of FIG. 4.

FIG. 6 is a cross-sectional schematic diagram of an electrically controllable viewing angle display unit according to another embodiment of the present disclosure.

FIG. 7A is a schematic diagram of the structure of an electrically controllable viewing angle display unit according to yet another embodiment of the present disclosure.

FIGS. 7B to 7D are schematic diagrams of light shapes of the electrically controllable viewing angle display unit of FIG. 7A when operating in different display modes.

FIG. 7E is a curve chart showing the brightness relative to the viewing angle of the electrically controllable viewing angle display unit of FIG. 7A when operating in different display modes.

FIG. 8A is a schematic diagram of the structure of an electrically controllable viewing angle display unit according to yet another embodiment of the present disclosure.

FIGS. 8B to 8D are schematic diagrams of light distributions of the electrically controllable viewing angle display unit of FIG. 8A when operating in different display modes.

FIG. 8E is a curve chart showing the brightness relative to the viewing angle of the electrically controllable viewing angle display unit of FIG. 8A when operating in different display modes.

FIG. 9 is another determination flowchart of the steps of the driving behavior warning method of FIG. 3A.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as "top," "bottom," "front," "back," etc., is used with reference to the orientation of the Figure(s) being described. The components of the present disclosure may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

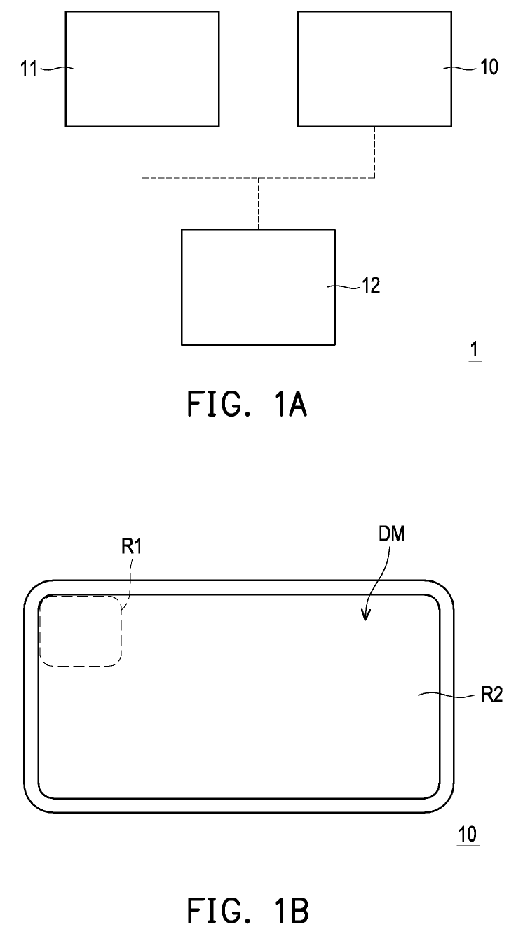

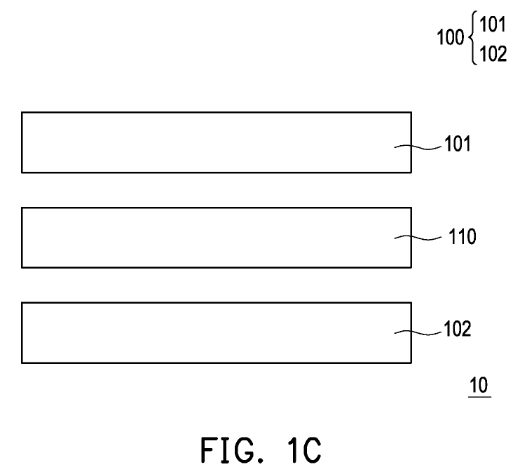

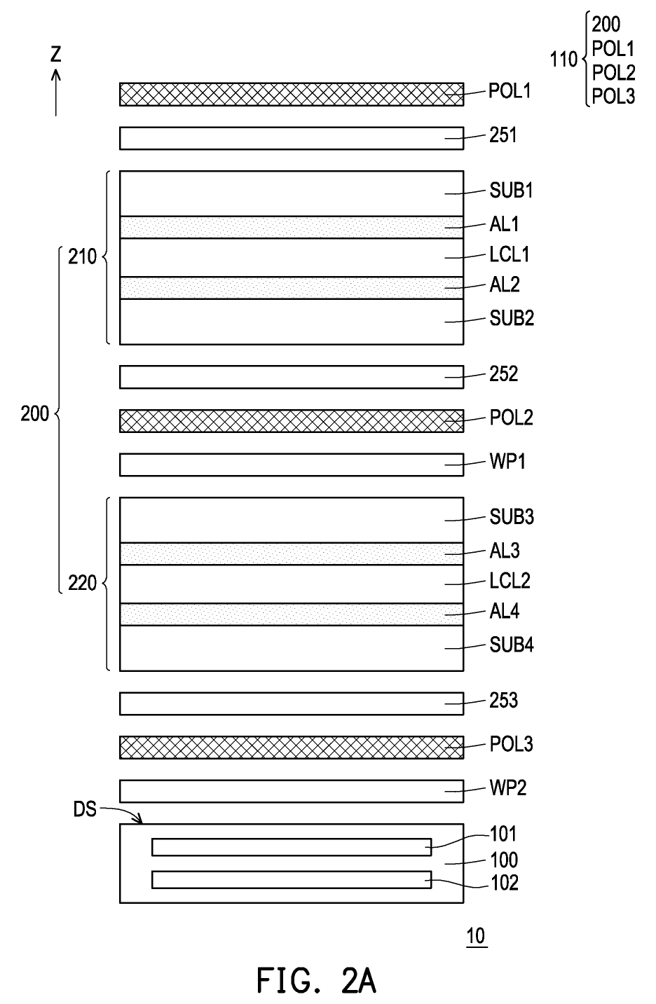

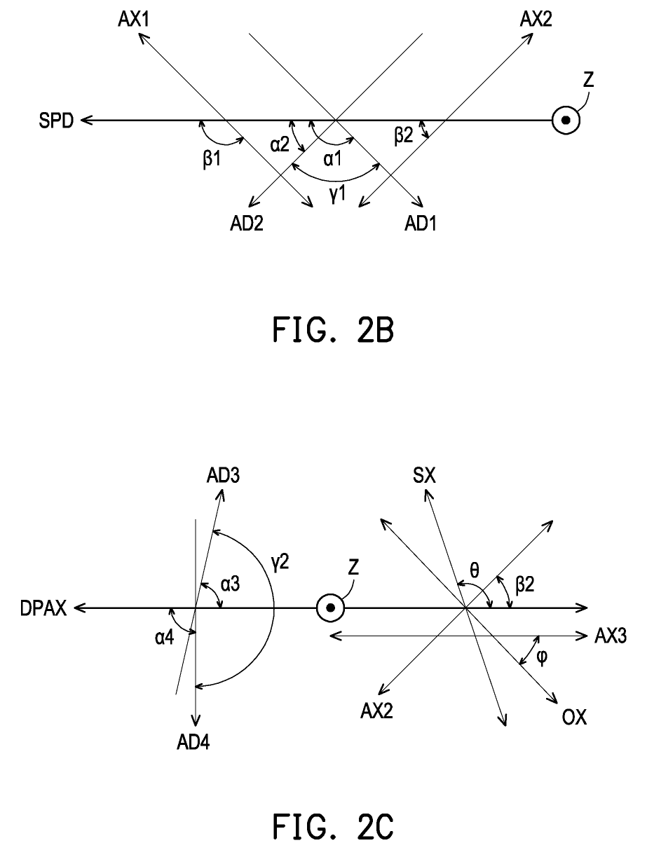

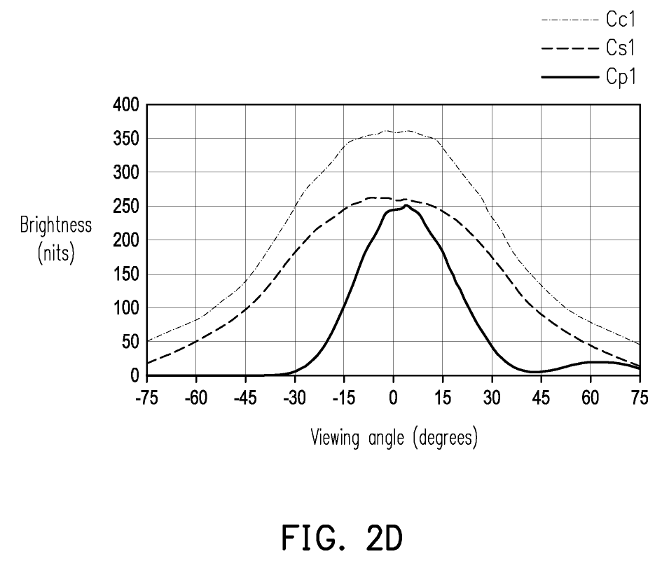

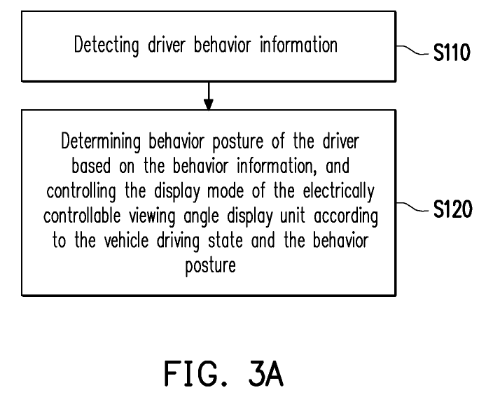

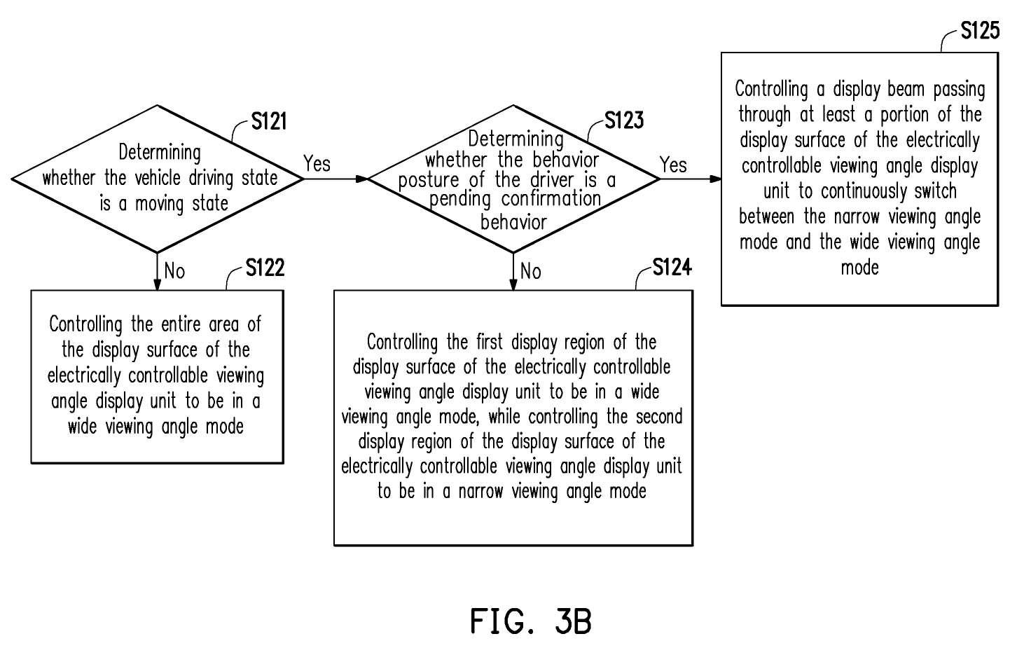

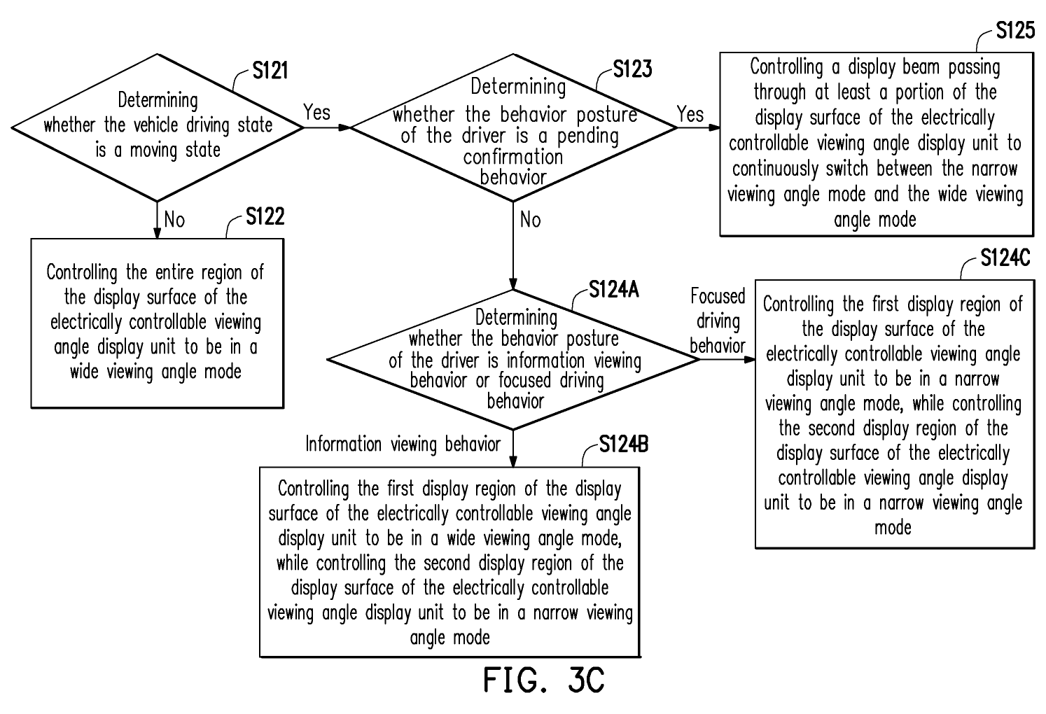

FIG. 1A is a block diagram of a driving behavior warning system according to an embodiment of the present disclosure. FIG. 1B is a front-view schematic diagram of a display surface of the electrically controllable viewing angle display unit of FIG. 1A. FIG. 1C is a cross-sectional schematic diagram of the electrically controllable viewing angle display unit of an embodiment of FIG. 1A. FIG. 2A is a cross-sectional schematic diagram of an electrically controllable viewing angle display unit according to another embodiment of the present disclosure. FIGS. 2B and 2C are schematic diagrams showing the configuration relationship of the alignment direction of the alignment layer, the axial direction of the absorption axis of the polarizer, and the axial direction of the slow axis of the half wave plate of FIG. 2A. FIG. 2D is a curve chart showing the brightness versus viewing angle of the electrically controllable viewing angle display unit of FIG. 2A when operating in different display modes. FIG. 3A is a flowchart of a driving behavior warning method according to an embodiment of the present disclosure. FIG. 3B is a flowchart of a determination control step of the driving behavior warning method of FIG. 3A. FIG. 3C is a determination flowchart of another determination control step of the driving behavior warning method of FIG. 3A. It is particularly noted that the angular configuration relationships shown in FIGS. 2B and 2C exemplify the angular configuration relationships in various directions as viewed from a top view of the electrically controllable viewing angle display unit 10. Similar angular configuration relationship diagrams in this disclosure follow the same principle and are not further elaborated herein.

Referring to FIGS. 1A and 1B, in this embodiment, the driving behavior warning system 1 includes a driving behavior detection unit 11, an electrically controllable viewing angle display unit 10, and a control unit 12. The driving behavior detection unit 11 is configured to detect the behavior information of a driver. The electrically controllable viewing angle display unit 10 is configured to provide a display beam (e.g., to display a display image). The control unit 12 is coupled to the driving behavior detection unit 11 and the electrically controllable viewing angle display unit 10. For example, in this embodiment, the control unit 12 is coupled to the driving behavior detection unit 11 and the electrically controllable viewing angle display unit 10 in a manner that includes utilizing a signal transmission line for electrical connection or a wireless transmission method for information exchange. In this way, the driving behavior warning system 1 may be configured to execute the driving behavior warning method shown in FIG. 3A, determine the behavior posture of the driver based on the behavior information of the driver, and control the display mode of the electrically controllable viewing angle display unit 10 according to the vehicle driving state and the behavior posture.

Referring to FIG. 1C, the electrically controllable viewing angle display unit 10 includes a display module 100 and a viewing angle electrical control module 110. The display module 100 is used, for example, to provide the display beam. The display module 100 is, for example, a self-luminous display. The self-luminous display includes, for example, an organic light-emitting diode (OLED) display panel, a micro light-emitting diode (micro-LED) display panel, or a mini light-emitting diode (mini-LED) display panel, but not limited thereto, and the viewing angle electrical control module 110 is disposed on a transmission path of the display beam. On the other hand, as shown in FIG. 1C, in one embodiment, the display module 100 is, for example, a non-self-luminous display, and the viewing angle electrical control module 110 may be disposed between the liquid crystal display panel 101 and the backlight module 102 of the display module 100. The non-self-luminous display includes, for example, a liquid crystal (LC) display panel and a backlight module 102. The backlight module 102 is configured to provide a backlight beam, and the backlight module 102 is, for example, an edge-type light source module (e.g., light source and light guide plate) or a direct-type light source module (e.g., light source and light guide element). The viewing angle electrical control module 110 is disposed on the transmission path of the backlight beam. The liquid crystal display panel 101 is disposed on the transmission path of the backlight beam from the viewing angle electrical control module 110, and modulates the backlight beam into the display beam. Alternatively, as shown in FIG. 2A, in this embodiment, a first electrically controlled viewing angle switch 210 of the viewing angle electrical control module 110 is disposed on one side of a display surface DS of the display module 100 including the liquid crystal display panel 101 and the backlight module 102.

The detailed structure of the electrically controllable viewing angle display unit 10 and its display mode of this embodiment are further explained below with reference to FIG. 2A to FIG. 2D.

Referring to FIG. 2A, the viewing angle electrical control module 110 includes an electrically controlled viewing angle switching module 200, a first polarizer POL1, a second polarizer POL2, and a third polarizer POL3. The electrically controlled viewing angle switching module 200 includes a first electrically controlled viewing angle switch 210 and a second electrically controlled viewing angle switch 220. The first electrically controlled viewing angle switch 210 is disposed on one side of the display surface DS of the display module 100. The second electrically controlled viewing angle switch 220 is disposed between the first electrically controlled viewing angle switch 210 and the display module 100. The first polarizer POL1 is disposed on one side of the first electrically controlled viewing angle switch 210 facing away from the second electrically controlled viewing angle switch 220. The second polarizer POL2 is disposed between the first electrically controlled viewing angle switch 210 and the second electrically controlled viewing angle switch 220. The third polarizer POL3 is disposed between the display module 100 and the second electrically controlled viewing angle switch 220.

More specifically, the third polarizer POL3, the second electrically controlled viewing angle switch 220, the second polarizer POL2, the first electrically controlled viewing angle switch 210 and the first polarizer POL1 are sequentially stacked on the display surface DS of the display module 100 and along the direction Z. The direction Z is, for example, perpendicular to the display surface DS.

The display module 100 is, for example, a non-self-luminous display or a self-luminous display.

The first electrically controlled viewing angle switch 210 includes a first substrate SUB1, a second substrate SUB2, a first liquid crystal layer LCL1, a first alignment layer AL1 and a second alignment layer AL2. The first alignment layer AL1 is disposed on the first substrate SUB1 and is located between the first liquid crystal layer LCL1 and the first polarizer POL1 (e.g., the first alignment layer AL1 is located between the first liquid crystal layer LCL1 and the first substrate SUB1). The second alignment layer AL2 is disposed on the second substrate SUB2 and is located between the first liquid crystal layer LCL1 and the second polarizer POL2 (e.g., the second alignment layer AL2 is located between the first liquid crystal layer LCL1 and the second substrate SUB2). The first liquid crystal layer LCL1 is disposed between the first alignment layer AL1 and the second alignment layer AL2.

The second electrically controlled viewing angle switch 220 includes a third substrate SUB3, a fourth substrate SUB4, a second liquid crystal layer LCL2, a third alignment layer AL3 and a fourth alignment layer AL4. The third alignment layer AL3 is disposed on the third substrate SUB3 and is located between the second liquid crystal layer LCL2 and the second polarizer POL2 (e.g., the third alignment layer AL3 is located between the second liquid crystal layer LCL2 and the third substrate SUB3). The fourth alignment layer AL4 is disposed on the fourth substrate SUB4 and is located between the second liquid crystal layer LCL2 and the third polarizer POL3 (e.g., the fourth alignment layer AL4 is located between the second liquid crystal layer LCL2 and the fourth substrate SUB4). The second liquid crystal layer LCL2 is disposed between the third alignment layer AL3 and the fourth alignment layer AL4.

The substrate material of the electrically controlled viewing angle switch may include glass, triacetyl cellulose (TAC), cyclo-olefin polymer (COP), polycarbonate (PC), polymethyl methacrylate (PMMA), polyimide (PI), other suitable polymers or plates with phase retardation properties (e.g., stretched compensation films).

The two alignment layers of each electrically controlled viewing angle switch are configured to determine the arrangement direction (arrangement state) of the liquid crystal layer in a natural state (e.g., without being affected by an electric field). In order to drive the liquid crystal layer, each electrically controlled viewing angle switch may further include two electrode layers (not shown) respectively disposed on opposite sides of the liquid crystal layer. When the two electrode layers are enabled to have a potential difference, multiple liquid crystal molecules (not shown) of the liquid crystal layer will be reoriented by the electric field formed between the two electrode layers. Specifically, in the present disclosure, the liquid crystal layer of the electrically controlled viewing angle switch may be driven in a twisted-nematic (TN) mode or an electrically controlled birefringence (ECB) mode.

Referring to FIG. 2A to FIG. 2C at the same time, in this embodiment, the first electrically controlled viewing angle switch 210 may have a single-sided anti-peeping direction SPD perpendicular to the direction Z, and the second electrically controlled viewing angle switch 220 may have a double-sided anti-peeping axial direction DPAX perpendicular to the direction Z. In detail, the double-sided anti-peeping axial direction DPAX includes a 90 degree direction and a -90 degree direction that are opposite to each other in the same dimension (e.g., the horizontal dimension (horizontal viewing angle) in FIG. 2C, the front viewing angle direction is 0 degrees, the front viewing angle direction is, for example, direction Z, and the viewing angle of the horizontal dimension ranges from 90 degrees to -90 degrees). The 90 degree direction is, for example, a direction toward the right side in FIG. 2C, and the -90 degree direction is, for example, a direction toward the left side in FIG. 2C.

In this embodiment, the single-sided anti-peeping direction SPD of the first electrically controlled viewing angle switch 210 may be parallel to the -90 degree direction of the double-sided anti-peeping axial direction DPAX of the second electrically controlled viewing angle switch 220, but not limited thereto. It is hereby clarified that the first electrically controlled viewing angle switch 210 may enable the electrically controlled viewing angle display unit 10 to have an anti-peeping effect within a viewing angle range on the side along the single-sided anti-peeping direction SPD, while the second electrically controlled viewing angle switch 220 may enable the electrically controlled viewing angle display unit 10 to have an anti-peeping effect within a viewing angle range on both sides along the double-sided anti-peeping axial direction DPAX.

For example, in this embodiment, the first alignment direction AD1 of the first alignment layer AL1 of the first electrically controlled viewing angle switch 210 may be selectively perpendicular to the second alignment direction AD2 of the second alignment layer AL2. That is, the first liquid crystal layer LCL1 of the first electrically controlled viewing angle switch 210 of this embodiment is driven in a twisted-nematic (TN) mode, and the included angle γ1 between the first alignment direction AD1 and the second alignment direction AD2 is 90 degrees (e.g., the included angle between the first alignment direction AD1 rotated clockwise to the second alignment direction AD2, angles in the present disclosure are similarly defined and are not be further elaborated herein). In this embodiment, the first alignment direction AD1 and the second alignment direction AD2 each form an included angle of 45 degrees or 135 degrees with respect to the single-sided anti-peeping direction SPD. For example, the included angle α1 between the first alignment direction AD1 and the single-sided anti-peeping direction SPD may be 135 degrees, and the included angle α2 between the second alignment direction AD2 and the single-sided anti-peeping direction SPD may be 45 degrees.

An included angle γ2 between the third alignment direction AD3 of the third alignment layer AL3 and the fourth alignment direction AD4 of the fourth alignment layer AL4 of the second electrically controlled viewing angle switch 220 may be greater than or equal to 150 degrees. In this embodiment, the third alignment direction AD3 and the fourth alignment direction AD4 each form an included angle that is greater than or equal to 75 degrees and less than or equal to 105 degrees with respect to the double-sided anti-peeping axial direction DPAX. For example, the included angle α3 between the third alignment direction AD3 and the 90 degree direction of the double-sided anti-peeping axial direction DPAX may be 85 degrees, and the included angle α4 between the fourth alignment direction AD4 and the -90 degree direction of the double-sided anti-peeping axial direction DPAX may be 90 degrees.

The maximum phase retardation of the first liquid crystal layer LCL1 may be greater than 0.8 μm, and preferably may be in the range of 1.04 μm to 1.1 μm. The maximum phase retardation of the second liquid crystal layer LCL2 is preferably greater than 0.5 μm and less than 1.2 μm. In this embodiment, the maximum phase retardation of the first liquid crystal layer LCL1 is, for example, 1.08 μm, and the maximum phase retardation of the second liquid crystal layer LCL2 is, for example, 0.933 μm.

The aforementioned maximum phase retardation is, for example, a product of a difference between an ordinary ray refractive index and an extraordinary ray refractive index of the liquid crystal molecules (not shown) of the liquid crystal layer and a thickness of the liquid crystal layer. It is particularly noted that, compared with the liquid crystal layer used in a general liquid crystal display panel, the liquid crystal layer of the electrically controlled viewing angle switch of the present disclosure has a significantly greater maximum phase retardation.

On the other hand, the first polarizer POL1, the second polarizer POL2, and the third polarizer POL3 respectively have a first absorption axis AX1, a second absorption axis AX2, and a third absorption axis AX3. In this embodiment, the axial direction of the first absorption axis AX1 of the first polarizer POL1 may be parallel to the first alignment direction AD1 of the first alignment layer AL1, and the axial direction of the third absorption axis AX3 of the third polarizer POL3 may be perpendicular to the fourth alignment direction AD4 of the fourth alignment layer AL4, but not limited thereto. In other embodiments, the axial direction of the first absorption axis AX1 may be perpendicular to the first alignment direction AD1, and the axial direction of the third absorption axis AX3 may be parallel to the fourth alignment direction AD4.

In this embodiment, the axial direction of the second absorption axis AX2 of the second polarizer POL2 may be perpendicular to the axial direction of the first absorption axis AX1 of the first polarizer POL1. The first absorption axis AX1 and the second absorption axis AX2 each form an included angle of 45 degrees or 135 degrees with respect to the single-sided anti-peeping direction SPD. For example, the included angle β1 between the first absorption axis AX1 and the single-sided anti-peeping direction SPD may be 135 degrees, and the included angle β2 between the second absorption axis AX2 and the single-sided anti-peeping direction SPD (or the double-sided anti-peeping axial direction DPAX) may be 45 degrees.

In this embodiment, the third absorption axis AX3 of the third polarizer POL3 may be parallel to the double-sided anti-peeping axial direction DPAX, but not limited thereto. In other embodiments, the included angle between the third absorption axis AX3 and the double-sided anti-peeping axial direction DPAX may be greater than 0 degree and less than or equal to 15 degrees.

The electrically controllable viewing angle display unit 10 may further selectively include a half wave plate WP1 and a quarter wave plate WP2. The half wave plate WP1 is disposed between the first electrically controlled viewing angle switch 210 and the second electrically controlled viewing angle switch 220. The quarter wave plate WP2 is disposed between the display module 100 and the third polarizer POL3, and an included angle φ between the third absorption axis AX3 and an optical axis OX of the quarter wave plate WP2 is 45 degrees.

It is particularly noted that an included angle θ between the slow axis SX of the half wave plate WP1 and the double-sided anti-peep axis DPAX may be (α3+β2+90 degrees)/2 or (α3+β2+90 degrees)/2+90 degrees. For example, in this embodiment, the included angle α3 between the third alignment direction AD3 and the 90 degree direction of the double-sided anti-peeping axial direction DPAX is 85 degrees, and the included angle β2 between the second absorption axis AX2 and the 90 degree direction of the double-sided anti-peeping axial direction DPAX is 45 degrees. Therefore, the included angle θ is 110 degrees, but not limited thereto. In another embodiment, the included angle θ may be 200 degrees.

In this embodiment, the electrically controllable viewing angle display unit 10 may further include a compensation film 251, a compensation film 252, and a compensation film 253. The compensation film 251 is disposed between the first polarizer POL1 and the first electrically controlled viewing angle switch 210. The compensation film 252 is disposed between the second polarizer POL2 and the second alignment layer AL2. The compensation film 253 is disposed between the third polarizer POL3 and the second electrically controlled viewing angle switch 220. However, the disclosure is not limited thereto. In other embodiments, the compensation film located between the two electrically controlled viewing angle switches may also be disposed between the second polarizer POL2 and the third alignment layer AL3, alternatively, no compensation film is disposed between the two electrically controlled viewing angle switches.

The out-of-plane phase retardation (Rth) of each of the compensation films 251, 252, and 253 may be in a range of -50 nm to -300 nm or in a range of 100 nm to 500 nm. The out-of-plane phase retardation here may be defined by the following relationship: Rth=[(nx+ny)/2-nz]*d, where nx and ny are the two refractive indices of the compensation film along two directions parallel to the film surface and perpendicular to each other respectively, nz is the refractive index of the compensation film along the direction perpendicular to the film surface, and d is the film thickness of the compensation film.

For example, in this embodiment, the sum of the out-of-plane phase retardation of the compensation film 251 and the compensation film 252 located between the first polarizer POL1 and the second polarizer POL2 may be -200 nm, and the out-of-plane phase retardation of the compensation film 253 located between the fourth alignment layer AL4 and the third polarizer POL3 may be 280 nm, but not limited thereto.

Referring to FIGS. 2A and 2D, the curve Cc1 serving as a reference curve is a distribution curve of the brightness versus the viewing angle of the display module 100. The curve Cs1 is a distribution curve of the brightness versus the viewing angle when the electrically controllable viewing angle display unit 10 operates in a sharing mode. The curve Cp1 is a distribution curve of the brightness versus the viewing angle when the electrically controllable viewing angle display unit 10 operates in an anti-peeping mode.

In this embodiment, when the electrically controllable viewing angle display unit 10 operates in the sharing mode, both the first electrically controlled viewing angle switch 210 and the second electrically controlled viewing angle switch 220 are not enabled. That is, the potential difference between the two electrode layers of the first electrically controlled viewing angle switch 210 is 0V (or close to 0V), and the potential difference between the two electrode layers of the second electrically controlled viewing angle switch 220 is 0V (or close to 0V). On the contrary, when the first electrically controlled viewing angle switch 210 and the second electrically controlled viewing angle switch 220 are enabled, the electrically controllable viewing angle display unit 10 operates in the anti-peeping mode. For example, when the potential difference between two electrode layers of the first electrically controlled viewing angle switch 210 is 2.9V and the potential difference between the two electrode layers of the second electrically controlled viewing angle switch 220 is 4.5V, the distribution curve of the brightness versus the viewing angle of the electrically controllable viewing angle display unit 10 is the curve Cp1 in FIG. 2D.

It should be noted that the portion of the viewing angle range with positive values in FIG. 2D corresponds to the horizontal viewing angle range on the 90 degree side of the double-sided anti-peeping axial direction DPAX in FIG. 2C, while the portion of the viewing angle range with negative values in FIG. 2D corresponds to the horizontal viewing angle range on the -90 degree side of the double-sided anti-peeping axial direction DPAX in FIG. 2C, and the front viewing angle direction (e.g., the direction Z) is 0 degrees.

As may be seen from FIG. 2D, the anti-peeping effect of the electrically controllable viewing angle display unit 10 operating in the anti-peeping mode in the left viewing angle range is significantly better than the anti-peeping effect in the right viewing angle range. This is due to the superposition of the light filtering effects of the first electrically controlled viewing angle switch 210 and the second electrically controlled viewing angle switch 220. In this embodiment, the first electrically controlled viewing angle switch 210 has a single-sided anti-peeping direction SPD toward the left side in FIG. 2B, and the second electrically controlled viewing angle switch 220 has a double-sided anti-peeping axial direction DPAX toward both sides in FIG. 2C. Therefore, the light filtering capability of the electrically controllable viewing angle display unit 10 in the left viewing angle range in FIG. 2C is better than the light filtering capability in the right viewing angle range.

Based on the above-mentioned light filtering characteristics, the electrically controllable viewing angle display unit 10 of this embodiment is suitable for application in a vehicle-mounted personal display. For example, taking a left-hand drive vehicle as an example, the driver's seat of the vehicle may be arranged within the negative viewing angle range of the electrically controllable viewing angle display unit 10. When the vehicle is traveling at night, the electrically controllable viewing angle display unit 10 may be switched to the aforementioned anti-peeping mode. At this time, the light filtering effect of the first electrically controlled viewing angle switch 210 and the second electrically controlled viewing angle switch 220 on the driver's side may enable the driver to remain unaffected by display beam emitted from the electrically controllable viewing angle display unit 10. In addition, the light filtering effect of the second electrically controlled viewing angle switch 220 within the positive viewing angle range may further reduce the brightness of the display beam reflected by the window of the front passenger seat. Accordingly, when the passenger on the front passenger seat uses the electrically controllable viewing angle display unit 10, it may also simultaneously ensure that the driver is not affected by the display beam, thereby improving the safety of the vehicle during nighttime driving.

Thus, in this embodiment, the anti-peeping mode of the electrically controllable viewing angle display unit 10 is the narrow viewing angle mode, the sharing mode of the electrically controllable viewing angle display unit 10 is the wide viewing angle mode. The electrically controllable viewing angle display unit 10 has the narrow viewing angle mode and the wide viewing angle mode, and may be switched between the narrow viewing angle mode and the wide viewing angle mode. The light emitting viewing angle range of the display beam in the narrow viewing angle mode is smaller than the light emitting viewing angle range of the display beam in the wide viewing angle mode. Further, in the narrow viewing angle mode, the brightness of the display beam in a first viewing angle direction (i.e., the viewing angle direction of the driver) of the electrically controllable viewing angle display unit 10 is less than 1% (e.g., the brightness of the front viewing angle is 100%), and in the wide viewing angle mode, the brightness of the display beam in the first viewing angle direction of the electrically controllable viewing angle display unit 10 is between 20% and 35%. The included angle between the first viewing angle direction and the normal direction of a display surface DM of the electrically controllable viewing angle display unit 10 is greater than 20 degrees, for example, 30 degrees. In this way, in the narrow viewing angle mode, the brightness of the display beam directed toward the viewing angle direction of the driver may be reduced, so that the driver cannot see the display image. When the electrically controllable viewing angle display unit 10 switches between the narrow viewing angle mode and the wide viewing angle mode, the display beam directed toward the driver presents a flickering effect to achieve a warning function.

In another embodiment, as shown in FIG. 1B, the electrically controllable viewing angle display unit 10 (e.g., the display surface DM) includes a first display region R1 and a second display region R2. The first display region R1 is closer to the driver than the second display region R2 (e.g., the geometric center of the first display region R1 is closer to the driver than the geometric center of the second display region R2), and the first display region R1 does not overlap the second display region R2. Specifically, the first electrically controlled viewing angle switch 210 (the second electrically controlled viewing angle switch 220) may control the viewing angle mode in partitions, and each partition, for example, corresponds to the first display region R1 and the second display region R2 (e.g., each electrode layer of each electrically controlled viewing angle switch has partition electrodes corresponding to the first display region R1 and the second display region R2, so that different voltages may be independently provided to the partition electrodes). By controlling the viewing angle modes of each partition of the first electrically controlled viewing angle switch 210 and the second electrically controlled viewing angle switch 220 of the electrically controlled viewing angle switching module 200, the electrically controlled viewing angle display unit 10 may independently control the switching of the first display region R1 and the second display region R2 between the narrow viewing angle mode and the wide viewing angle mode. For example, when the first display region R1 is controlled in a wide viewing angle mode and the second display region R2 is controlled in a narrow viewing angle mode, the brightness of the display beam of the second display region R2 directed toward the viewing angle of the driver may be reduced, so that the driver will not be able to view the display image of the second display region R2, but may view the display image of the first display region R1 without being affected.

Next, referring to FIGS. 1A and 3A again, in this embodiment, the driving behavior detection unit 11 is, for example, at least one camera, for executing the detection step S110 of the driving behavior warning method shown in FIG. 3A. The driving behavior detection unit 11 captures at least one behavior information of the driver. Next, the control unit 12 may execute the determination control step S120 of the driving behavior warning method as shown in FIG. 3A. The behavior posture of the driver is determined based on the at least one behavior information captured by the driving behavior detection unit 11, and the display mode of the electrically controllable viewing angle display unit 10 is controlled according to the vehicle driving state and the behavior posture. For example, the behavior posture of the driver may include a normal behavior and an unconfirmed behavior, and the vehicle driving state may include a moving state and a stationary (stopped) state. Specifically, in this embodiment, the driving behavior detection unit 11 only includes a single camera, and the behavior information is head behavior image information. In this embodiment, a single camera is used to identify and determine the behavior posture of the driver, which has a simple structure, is relatively easy to install and has low cost. Furthermore, since only a single imaging element is configured, the processing speed is faster. In this case, the driving behavior detection unit 11 is generally configured to detect the head behavior of the driver, such as up and down or horizontal movements, and the behavior information of the driver is formed according to the head behavior image information. For example, when the driver is dozing off due to fatigue driving, the head behavior of the driver frequently exhibits up and down or horizontal movements greater than a specified range. Therefore, in this embodiment, when the behavior information received by the control unit 12 exhibits movement information greater than the specified range, the control unit 12 determines that the behavior posture of the driver is an unconfirmed behavior.

Furthermore, as shown in FIGS. 3A and 3B, in this embodiment, step S120 may include step S121, step S122, step S123, step S124 and step S125. In step S121, whether the vehicle driving state is a moving state is determined. When it is determined to be no, step S122 is executed; when it is determined to be yes, step S123 is executed. In step S123, whether the behavior posture of the driver is an unconfirmed behavior is determined. When it is determined to be no, step S124 is executed; when it is determined to be yes, step S125 is executed. That is, when the behavior posture of the driver is an unconfirmed behavior and the vehicle driving state is a moving state, the control unit 12 executes step S125 to control at least a portion of the display surface DM of the electrically controllable viewing angle display unit 10 to continuously switch between the narrow viewing angle mode and the wide viewing angle mode. Specifically, in the embodiment of FIG. 1B, at least a portion of the display surface DM of the electrically controllable viewing angle display unit 10 is located in the first display region R1. In this way, the display beam in the viewing angle direction toward the driver may form a flickering effect to realize a warning function, thereby reminding the driver to take break to ensure driving safety. It is particularly noted that in step S125, the second display region R2 is, for example, maintained in the narrow viewing angle mode. In another embodiment, the second display region R2 may be continuously switched between the narrow viewing angle mode and the wide viewing angle mode along with the first display region R1 (in other words, entire region of the display surface DM is the first display region R1). In one embodiment, a switching frequency between the narrow viewing angle mode and the wide viewing angle mode is less than 4 Hz. This lower frequency flickering effect does not induce excessive neural synchronization activity, which may significantly reduce the risk of epileptic seizures in photosensitive patients or patients with epilepsy. Furthermore, in the embodiment of FIG. 1B, since the flickering effect is formed only in the viewing angle direction toward the driver, the influence of the warning effect of the electrically controllable viewing angle display unit 10 on the front seat passenger may be effectively reduced.

On the other hand, as shown in FIG. 3B, in this embodiment, when the control unit 12 determines that the behavior posture of the driver is a normal behavior (step S123 is determined to be no) and the vehicle driving state is a moving state (step S121 is determined to be yes), the control unit 12 executes step S124 to control the first display region R1 of the display surface DM of the electrically controllable viewing angle display unit 10 to be in a wide viewing angle mode (to be maintained in the wide viewing angle mode), and control the second display region R2 of the display surface DM of the electrically controllable viewing angle display unit 10 to be maintained in a narrow viewing angle mode. In this way, the driver may see the required information displayed in the first display region R1, and the driver is not affected by the display beam emitted from the second display region R2, thereby improving the safety of vehicle driving. In addition, when the control unit 12 determines that the vehicle driving state is a stationary state (step S121 is determined to be no), the control unit 12 executes step S122 to control the entire region of the display surface DM of the electrically controllable viewing angle display unit 10 to be in a wide viewing angle mode, which may be viewed by the driver and the passenger at the same time.

In this way, in this embodiment, when the behavior posture of the driver is an unconfirmed behavior and the vehicle driving state is a moving state, the driving behavior warning system 1 and the driving behavior warning method control the electrically controllable viewing angle display unit 10 to continuously switch between the narrow viewing angle mode and the wide viewing angle mode, so that the display beam in the viewing angle direction toward the driver has a flickering effect, thereby realizing the warning function for the driver and ensuring the safety of vehicle driving.

In addition, it is worth noting that in the aforementioned embodiment, although the driving behavior detection unit 11 takes a single camera as an example, the present disclosure is not limited thereto. In other embodiments, the driving behavior detection unit 11 may also include multiple cameras, which may be configured to obtain various behavior information of the driver. For example, when the driving behavior detection unit 11 includes multiple cameras, the control unit 12 may establish the head behavior depth image information of the driver based on multiple head behavior image information captured by the cameras, and thereby obtain the behavior information of the driver. In this way, the behavior posture of the driver may be determined more accurately and the misjudgment rate may be effectively reduced. Furthermore, since the behavior information of the driver is more accurate, when the driving behavior detection unit 11 includes multiple cameras, the control unit 12 may adopt the determination process shown in FIG. 3C when executing the determination control step S120 of FIG. 3A. That is, the determination control step S120 may include step S121, step S122, step S123, step S125, step S124A, step S124B and step S124C.

In this embodiment, step S121, step S122, step S123 and step S125 are as described above and are not repeated herein. When step S123 is determined to be no, step S124A is executed. In step S124A, whether the behavior posture of the driver is information viewing behavior or focused driving behavior is determined. Furthermore, since the head behavior depth image information of the driver may more accurately determine the behavior posture of the driver, the behavior posture of the driver may be further analyzed according to the head behavior depth image information, such as whether there is only a simple turn or a change in line of sight. For example, when driving a vehicle normally, the driver may also look at the first display region R1 of the display surface DM of the electrically controllable viewing angle display unit 10 and thereby obtain necessary information. Accordingly, in this embodiment, when the head behavior depth image information shows a simple turn or a change in line of sight, in step S124A, the control unit 12 determines that the behavior posture of the driver is the information viewing behavior. When the head behavior depth image information does not change, the control unit 12 determines that the behavior posture of the driver is the focused driving behavior.

When the control unit 12 determines that the behavior posture of the driver is the information viewing behavior, the control unit 12 executes step S124B to control the first display region R1 of the display surface DM of the electrically controllable viewing angle display unit 10 to be in a wide viewing angle mode, and control the second display region R2 of the display surface DM of the electrically controllable viewing angle display unit 10 to be in a narrow viewing angle mode. In this way, the driver may obtain the information displayed on the display surface DM of the electrically controllable viewing angle display unit 10, and when the passenger on the front passenger seat is using the electrically controllable viewing angle display unit 10, it may also ensure that the driver is not affected by the display beam of the second display region R2, thereby improving the safety of vehicle driving. When the control unit 12 determines that the behavior posture of the driver is the focused driving behavior, the control unit 12 executes step S124C to control the first display region R1 of the display surface DM of the electrically controllable viewing angle display unit 10 to be in the narrow viewing angle mode, and control the second display region R2 of the display surface DM of the electrically controllable viewing angle display unit 10 to be in the narrow viewing angle mode. In this way, the driver is not disturbed by the image of the electrically controllable viewing angle display unit 10.

Other embodiments are described below to explain the disclosure in detail, and the same components will be denoted by the same reference numerals, and the description of the same technical content will be omitted. For the description of the omitted part, reference may be made to the above embodiment, and details are not described in the following embodiments.

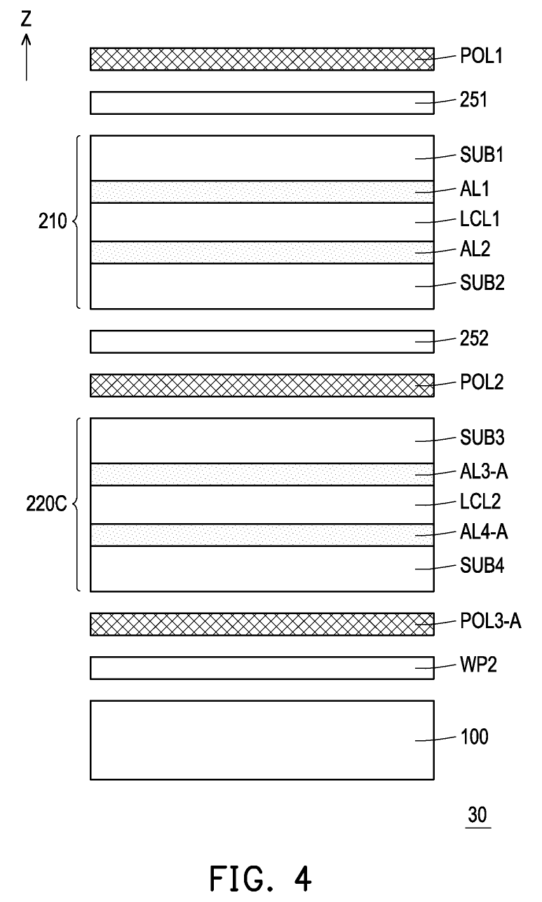

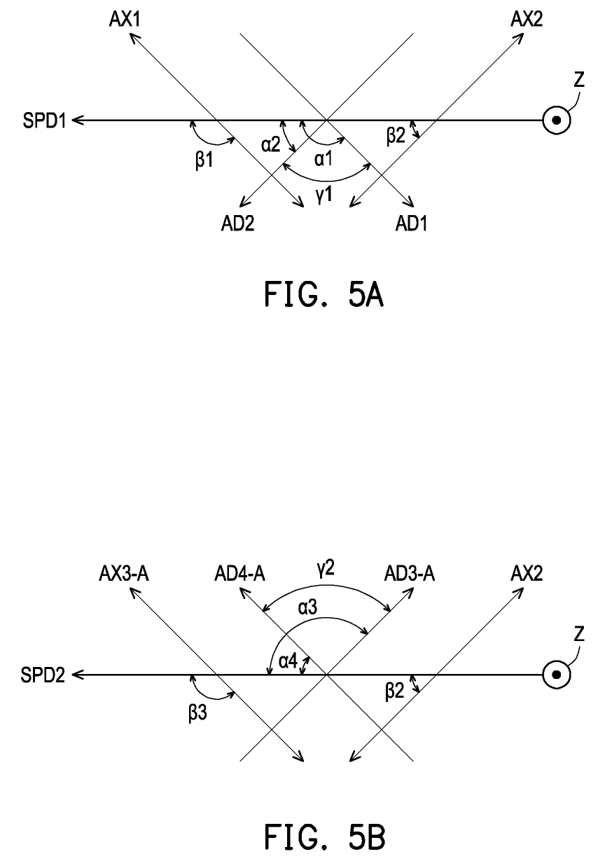

FIG. 4 is a cross-sectional schematic diagram of an electrically controllable viewing angle display unit according to another embodiment of the present disclosure. FIG. 5A and FIG. 5B are schematic diagrams showing the configuration relationship of the alignment direction of the alignment layer and the axial direction of the absorption axis of the polarizer of FIG. 4.

Referring to FIGS. 4, 5A and 5B, the main difference between the electrically controllable viewing angle display unit 30 of this embodiment and the electrically controllable viewing angle display unit 10 of FIG. 2A is that the design of the second electrically controlled viewing angle switch is different. Specifically, in this embodiment, the handedness of the twisted arrangement of the second liquid crystal layer LCL2 of the second electrically controlled viewing angle switch 220C between the third alignment layer AL3-A and the fourth alignment layer AL4-A is different from the handedness of the twisted arrangement of the first liquid crystal layer LCL1 of the first electrically controlled viewing angle switch 210 between the first alignment layer AL1 and the second alignment layer AL2.

In detail, the included angle α3 between the second single-sided anti-peeping direction SPD2 and the third alignment direction AD3-A of the third alignment layer AL3-A may be 135 degrees. The included angle α4 between the second single-sided anti-peeping direction SPD2 and the fourth alignment direction AD4-A of the fourth alignment layer AL4-A may be 45 degrees. More specifically, in this embodiment, the third alignment direction AD3-A is anti-parallel to the second alignment direction AD2, and the fourth alignment direction AD4-A is anti-parallel to the first alignment direction AD1.

From another point of view, in this embodiment, the handedness of the twisted arrangement of the second liquid crystal layer LCL2 of the second electrically controlled viewing angle switch 220C between the third alignment layer AL3-A and the fourth alignment layer AL4-A is, for example, right-handed, while the handedness of the twisted arrangement of the first liquid crystal layer LCL1 of the first electrically controlled viewing angle switch 210 between the first alignment layer AL1 and the second alignment layer AL2 is, for example, left-handed.

In this embodiment, the third absorption axis AX3-A of the third polarizer POL3-A may be parallel to the first absorption axis AX1 of the first polarizer POL1 and the fourth alignment direction AD4-A of the fourth alignment layer AL4-A. The included angle β3 between the third absorption axis AX3-A and the second single-sided anti-peeping direction SPD2 is, for example, 135 degrees.

The maximum phase retardation of each of the first liquid crystal layer LCL1 and the second liquid crystal layer LCL2 may be greater than 0.8 μm, and preferably may be in the range of 1.04 μm to 1.1 μm. In this embodiment, the maximum phase retardation of each of the first liquid crystal layer LCL1 and the second liquid crystal layer LCL2 is, for example, 1.08 μm.

It is particularly noted that due to the configuration relationship between the first electrically controlled viewing angle switch 210 and the second electrically controlled viewing angle switch 220C, the electrically controllable viewing angle display unit 30 of this embodiment is not provided with a compensation film 253 as shown in FIG. 1 between the second electrically controlled viewing angle switch 220C and the third polarizer POL3-A. Since the other components not mentioned are similar to the electrically controllable viewing angle display unit 10 of FIG. 2A, please refer to the relevant paragraphs of the aforementioned embodiment for detailed description, which are not repeated herein.

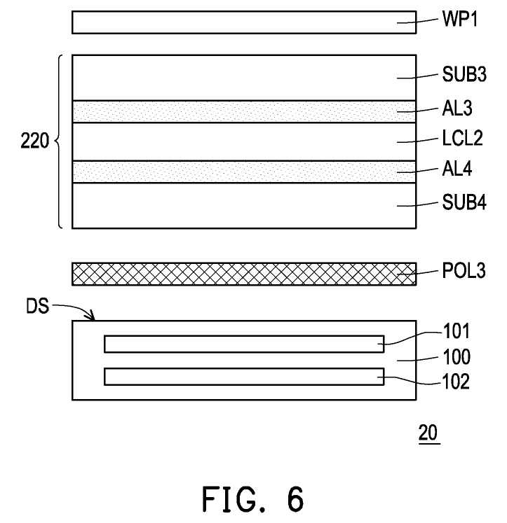

FIG. 6 is a cross-sectional schematic diagram of an electrically controllable viewing angle display unit according to another embodiment of the present disclosure. The main difference between the electrically controllable viewing angle display unit 20 of this embodiment and the electrically controllable viewing angle display unit 10 of FIG. 2A is that the electrically controllable viewing angle display unit 20 of this embodiment does not have the first electrically controlled viewing angle switch 210 but only has the second electrically controlled viewing angle switch 220. For the detailed configuration and related descriptions of the second electrically controlled viewing angle switch 220, reference may be made to the relevant paragraphs of the aforementioned embodiment, which are not repeated herein.

In this way, through the configuration of the second electrically controlled viewing angle switch 220, the electrically controllable viewing angle display unit 20 may also have an anti-peeping effect within the viewing angle range on both sides along the double-sided anti-peeping axial direction DPAX.

Thus, the electrically controllable viewing angle display units 20 and 30 of the embodiments of the present disclosure may also be electrically switched in the viewing angle range in at least one direction to meet different usage scenarios and reduce the light emission of the electrically controllable viewing angle display units 20 and 30 within the anti-peeping viewing angle range. In this way, when the electrically controllable viewing angle display units 20 and 30 are applied to the aforementioned driving behavior warning system 1 to replace the electrically controllable viewing angle display unit 10, the aforementioned driving behavior warning system 1 and driving behavior warning method may still achieve the aforementioned functions and effects, and other related details are not repeated herein. It is particularly noted that the number and the structure of the electrically controlled viewing angle switch of the present disclosure are not limited to the above-mentioned embodiments. In other embodiments, different combinations of the above-mentioned electrically controlled viewing angle switches or other electrically controlled viewing angle switches may be used in the electrically controlled viewing angle display unit according to different situations to achieve the effect of reducing the light emission within the anti-peeping viewing angle range.

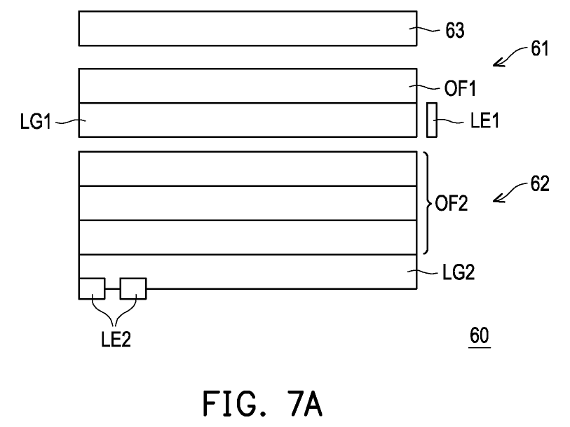

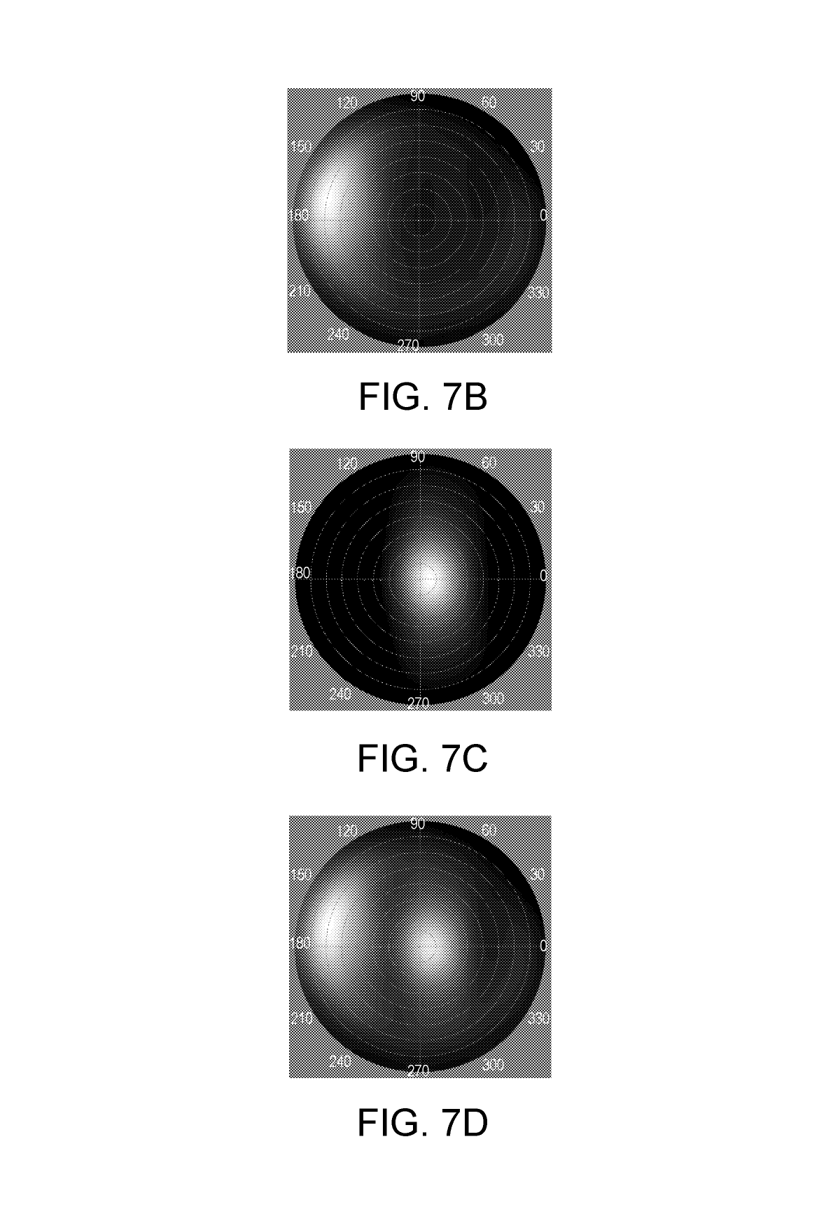

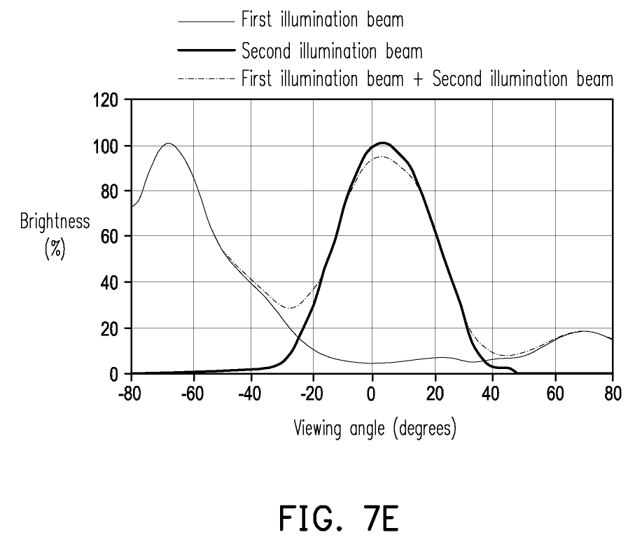

In addition, it is worth noting that in the aforementioned embodiments, regarding the electrically controllable viewing angle display units 10, 20, and 30, although the switching between wide viewing angle mode and narrow viewing angle mode is exemplified through the enablement or non-enablement of the first electrically controlled viewing angle switch and the second electrically controlled viewing angle switch, the present disclosure is not limited thereto. In other embodiments, the electrically controllable viewing angle display unit may also realize switching between the wide viewing angle mode and the narrow viewing angle mode of the electrically controlled viewing angle display unit by switching the illumination beam serving as the source of the display beam. Further explanation is given below with reference to FIGS. 7A to 9.

FIG. 7A is a schematic diagram of the structure of an electrically controllable viewing angle display unit according to yet another embodiment of the present disclosure. FIGS. 7B to 7D are schematic diagrams of light shapes of the electrically controllable viewing angle display unit of FIG. 7A when operating in different display modes. FIG. 7E is a curve chart showing the brightness relative to the viewing angle of the electrically controllable viewing angle display unit of FIG. 7A when operating in different display modes. Referring to FIGS. 7A to 7E, in this embodiment, the electrically controllable viewing angle display unit 60 includes a first light source module 61, a second light source module 62 and a display module 63. Specifically, the first light source module 61 includes a first light source LE1, a first light guide plate LG1 and a first optical film set OF1, and may be configured to provide a first illumination beam. The second light source module 62 includes a second light source LE2, a second light guide plate LG2 and a second optical film set OF2, and may be configured to provide a second illumination beam. The first light source module 61 is, for example, an edge-type light source module, and the second light source module 62 is, for example, a direct-type light source module. In other embodiments, the first light source module 61 and the second light source module 62 may both be edge-type light source modules. The first light source LE1 and the second light source LE2 are, for example, light emitting diodes or laser diodes, the display module 63 is, for example, non-self-luminous display.

Furthermore, in this embodiment, the first optical film set OF1 includes a reflective brightness enhancement film, and the second optical film set OF2 includes optical films such as a louver film or a prism group. In this way, as shown in FIG. 7B, when only the first light source module 61 is turned on, the first illumination beam is only emitted in the laterally direction of the electrically controllable viewing angle display unit 60 (e.g., the light emission direction of the main beam of the first illumination beam is, for example, -68 degrees, and the light intensity of the light emission at the front viewing angle of the electrically controllable viewing angle display unit 60 is, for example, less than 20%). On the other hand, as shown in FIG. 7C, when only the second light source module 62 is turned on, the second illumination beam is emitted in the front viewing angle direction of the electrically controllable viewing angle display unit 60 (the light emission direction of the main beam is, for example, 5 degrees, and the light intensity of the light emission at a viewing angle of -68 degrees is, for example, less than 20%). When the first light source module 61 and the second light source module 62 are turned on at the same time, the front viewing angle direction and the lateral direction of the electrically controllable viewing angle display unit 60 may both be within the light emitting viewing angle range. For example, as shown in FIG. 7E, the light intensity of the first illumination beam in the viewing angle direction toward the driver is more than 5 times the light intensity of the second illumination beam in the viewing angle direction toward the driver, and may be configured to provide light beam in the viewing angle direction toward the driver.

Thus, in this embodiment, when the electrically controllable viewing angle display unit 60 only turns on the second light source module 62, the electrically controllable viewing angle display unit 60 is in a narrow viewing angle mode, and when the electrically controllable viewing angle display unit 60 turns on the first light source module 61 and the second light source module 62 at the same time, the electrically controllable viewing angle display unit 60 is in a wide viewing angle mode. That is, in this embodiment, when the electrically controllable viewing angle display unit 60 is in the narrow viewing angle mode, the display beam is the second illumination beam, and when the electrically controllable viewing angle display unit 60 is in the wide viewing angle mode, the display beam includes the first illumination beam and the second illumination beam. Furthermore, since the first illumination beam for providing light beam in the viewing angle direction toward the driver is not turned on in the narrow viewing angle mode, it is difficult for the driver to see the display image of the electrically controllable viewing angle display unit 60.

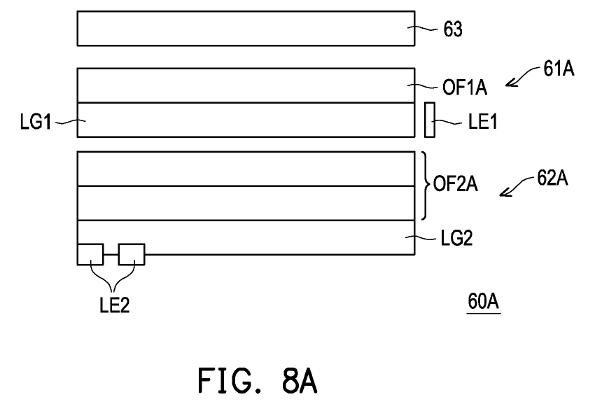

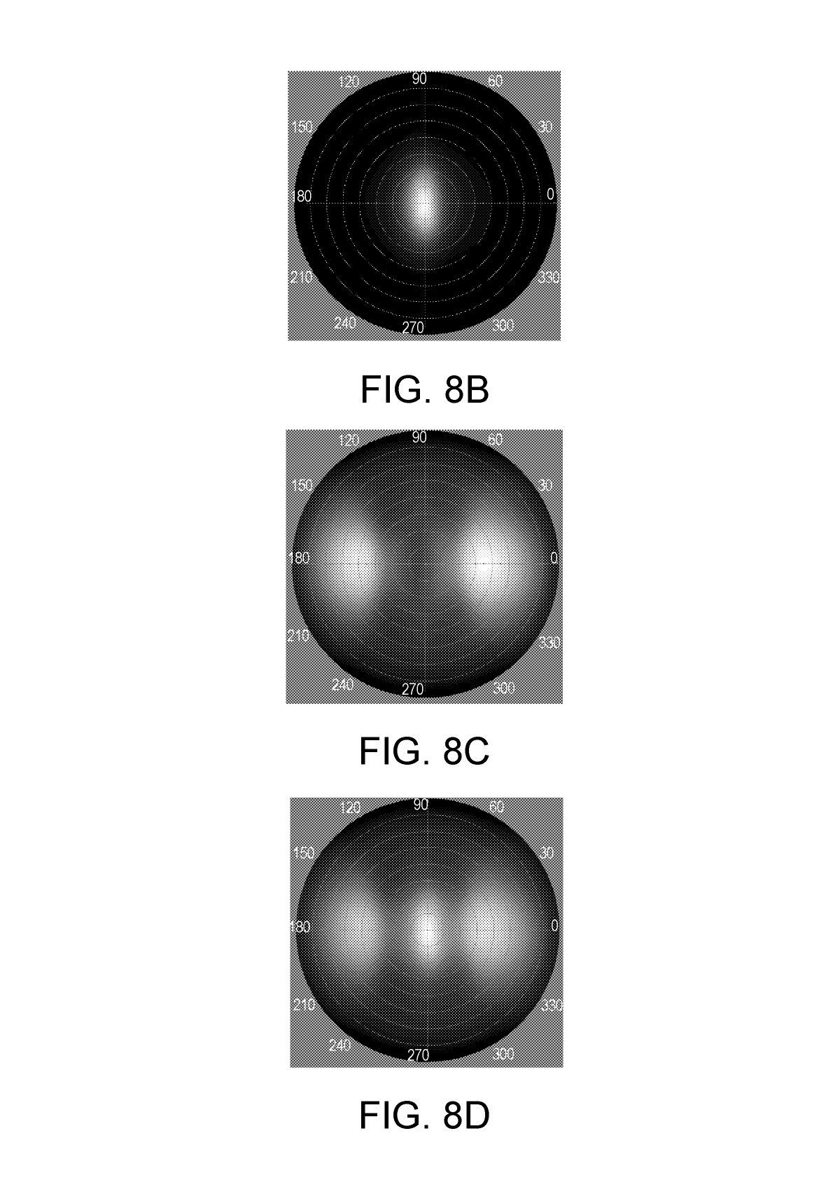

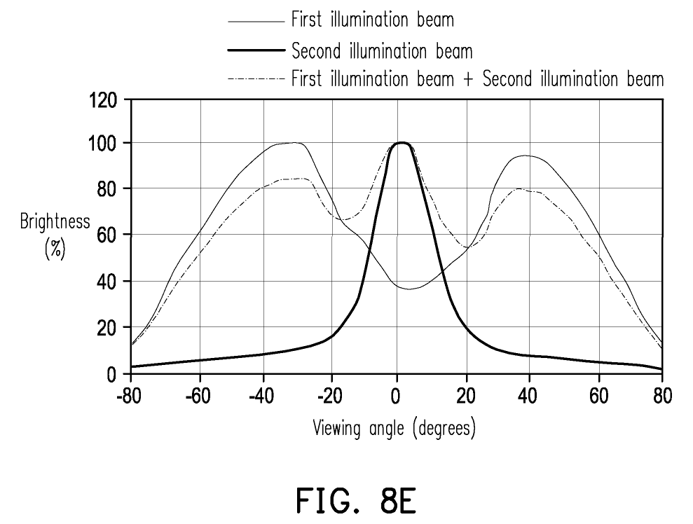

FIG. 8A is a schematic diagram of the structure of an electrically controllable viewing angle display unit according to yet another embodiment of the present disclosure. FIG. 8B to FIG. 8D are schematic diagrams of light distributions of the electrically controllable viewing angle display unit of FIG. 8A when operating in different display modes. FIG. 8E is a curve chart showing the brightness relative to the viewing angle of the electrically controllable viewing angle display unit of FIG. 8A when operating in different display modes. Referring to FIG. 8A to FIG. 8B, in the embodiment of FIG. 8A, the electrically controllable viewing angle display unit 60A is similar to the electrically controllable viewing angle display unit 60 of FIG. 7A, and the difference between the two is as follows.

In this embodiment, the first optical film set OF1A of the first light source module 61A of the electrically controllable viewing angle display unit 60A includes an inverse prism, and the second optical film set OF2A of the second light source module 62A includes optical films such as a prism and a diffuser. The first light source module 61A is, for example, an edge-type light source module, and the second light source module 62A is, for example, a direct-type light source module. Thus, as shown in FIG. 8B, when only the first light source module 61A is turned on, the first illumination beam is focused and emitted in the front viewing angle direction of the electrically controllable viewing angle display unit 60A. On the other hand, as shown in FIG. 8C, when only the second light source module 62A is turned on, the second illumination beam is emitted in the two lateral directions of the electrically controllable viewing angle display unit 60A (the light emission direction of the main beam is, for example, 35 degrees and -35 degrees, and the light intensity of the light emission at the front viewing angle is, for example, less than 50%). In this way, when the first light source module 61A and the second light source module 62A are turned on at the same time, the front viewing angle direction and the two lateral directions of the electrically controllable viewing angle display unit 60A may be within the light emitting viewing angle range. For example, as shown in FIG. 8E, the light intensity of the second illumination beam in the viewing angle direction of the driver is more than 5 times the light intensity of the first illumination beam in the viewing angle direction of the driver, and may be configured to provide brightness in the viewing angle direction of the driver.

Thus, in this embodiment, when the electrically controllable viewing angle display unit 60A only turns on the first light source module 61A, the electrically controllable viewing angle display unit 60A is in a narrow viewing angle mode, and when the electrically controllable viewing angle display unit 60A turns on the first light source module 61A and the second light source module 62A at the same time, the electrically controllable viewing angle display unit 60A is in a wide viewing angle mode. That is, in this embodiment, when the electrically controllable viewing angle display unit 60A is in the narrow viewing angle mode, the display beam includes the first illumination beam, and when the electrically controllable viewing angle display unit 60A is in the wide viewing angle mode, the display beam includes the first illumination beam and the second illumination beam. Furthermore, since the second illumination beam for providing light beam in the viewing angle direction toward the driver is not turned on in the narrow viewing angle mode, it is difficult for the driver to see the display image of the electrically controllable viewing angle display unit 60A.

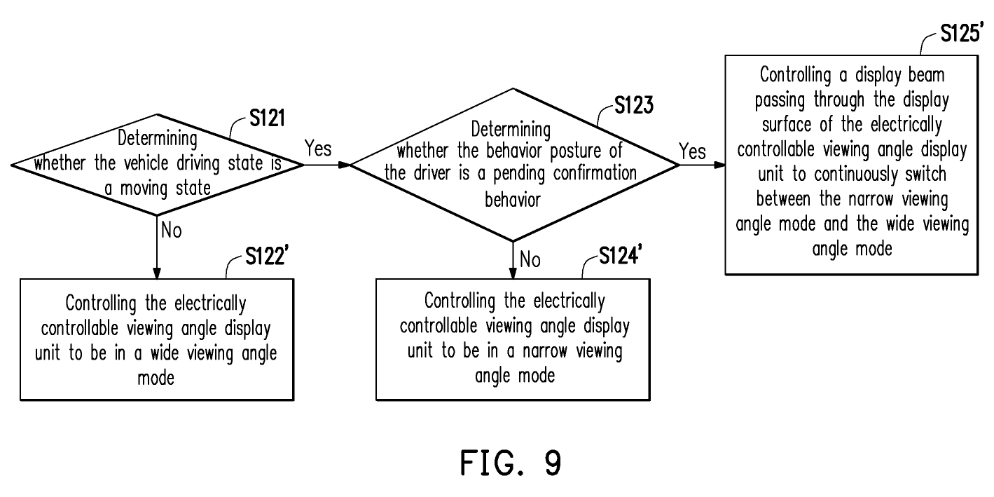

In this way, the electrically controllable viewing angle display units 60 and 60A may also be electrically switched in the viewing angle range in at least one direction to meet different usage scenarios. Therefore, the electrically controlled viewing angle display units 60 and 60A may still be applied to the aforementioned driving behavior warning system 1 to replace the electrically controllable viewing angle display unit 10, and may be configured to execute the driving behavior warning method shown in FIGS. 3A and 9. The behavior posture of the driver is determined based on the behavior information, and the display mode of the electrically controllable viewing angle display unit is controlled according to the vehicle driving state and the behavior posture.

Furthermore, as shown in FIGS. 3A and 9, in this embodiment, the determination control step S120 may include step S121, step S122', step S123, step S124' and step S125'. When the behavior posture of the driver is an unconfirmed behavior and the vehicle driving state is a moving state, the control unit 12 executes step S125' to control the display beam passing through the display surface DM of the electrically controllable viewing angle display units 60 and 60A to continuously switch between the narrow viewing angle mode and the wide viewing angle mode. In this way, a flickering effect may be generated in the direction of the viewing angle direction of the driver to achieve a warning function, thereby reminding the driver of his need for rest to ensure driving safety. On the other hand, in this embodiment, when the control unit 12 determines that the behavior posture of the driver is a normal behavior and the vehicle driving state is a moving state, the control unit 12 executes step S124' to control the electrically controllable viewing angle display units 60 and 60A to be in narrow viewing angle mode. In this way, when the passenger on the front passenger seat uses the electrically controllable viewing angle display unit, it may also simultaneously ensure that the driver is not affected by the display beam, thereby improving the safety of the vehicle during nighttime driving. In addition, when the control unit 12 determines that the vehicle is a stationary state, the control unit 12 executes step S122' to control the electrically controllable viewing angle display units 60 and 60A to be in a wide viewing angle mode, which may be viewed by the driver and the passenger at the same time.

In this way, in this embodiment, when the behavior posture of the driver is an unconfirmed behavior and the vehicle driving state is a moving state, the driving behavior warning system 1 and the driving behavior warning method may continuously switch between the narrow viewing angle mode and the wide viewing angle mode through the driving behavior warning system 1, so that the display beam transmitted in the viewing angle direction of the driver generates a flickering effect, thereby realizing the warning function and ensuring driving safety. Thus, when the electrically controlled viewing angle display units 60 and 60A are applied to the aforementioned driving behavior warning system 1 to replace the electrically controlled viewing angle display unit 10, the aforementioned driving behavior warning system 1 may still achieve the aforementioned functions and effects, and other related details are not repeated herein.

To sum up, in a driving behavior warning system and a driving behavior warning method of one embodiment of the present disclosure, when the behavior posture of the driver is an unconfirmed behavior and the vehicle driving state is a moving state, the driving behavior warning system and the driving behavior warning method may continuously switch between the narrow viewing angle mode and the wide viewing angle mode through the driving behavior warning system, so that the display beam transmitted in the viewing angle direction of the driver generates a flickering effect, thereby realizing the warning function and ensuring driving safety.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A driving behavior warning system, wherein the driving behavior warning system comprises a driving behavior detection unit, an electrically controllable viewing angle display unit and a control unit, wherein:
the driving behavior detection unit is configured to detect behavior information of a driver;
the electrically controllable viewing angle display unit is configured to provide a display beam and has a narrow viewing angle mode and a wide viewing angle mode, wherein a light emitting viewing angle range of the display beam in the narrow viewing angle mode is smaller than a light emitting viewing angle range of the display beam in the wide viewing angle mode; and
the control unit is coupled to the driving behavior detection unit and the electrically controllable viewing angle display unit, wherein the control unit determines behavior posture of the driver based on the behavior information, the behavior posture comprises a normal behavior and an unconfirmed behavior, and the control unit controls a display mode of the electrically controllable viewing angle display unit according to a vehicle driving state and the behavior posture, wherein the vehicle driving state comprises a moving state and a stationary state, wherein the control unit controls at least a portion of the electrically controllable viewing angle display unit to continuously switch between the narrow viewing angle mode and the wide viewing angle mode when the behavior posture is the unconfirmed behavior and the vehicle driving state is the moving state.

2. The driving behavior warning system according to claim 1, wherein the driving behavior detection unit comprises at least one camera element configured to capture at least one of the behavior information.

3. The driving behavior warning system according to claim 2, wherein the control unit determines that the behavior posture of the driver is the unconfirmed behavior when the behavior information exhibits movement information greater than a specified range.

4. The driving behavior warning system according to claim 3, wherein the control unit controls the at least a portion of the electrically controllable viewing angle display unit to be in the wide viewing angle mode when the control unit determines that the behavior posture of the driver is the normal behavior and the vehicle driving state is the moving state.

5. The driving behavior warning system according to claim 1, wherein the electrically controllable viewing angle display unit comprises an electrically controlled viewing angle switching module, the electrically controllable viewing angle display unit comprises a first display region and a second display region, the first display region is closer to the driver than the second display region, and the at least a portion of the electrically controllable viewing angle display unit is located in the first display region, and the at least a portion of the electrically controllable viewing angle display unit does not overlap the second display region, the electrically controlled viewing angle switching module reduces brightness of the display beam directed toward the driver in the narrow viewing angle mode.

6. The driving behavior warning system according to claim 1, wherein the electrically controllable viewing angle display unit comprises a first light source module and a second light source module, wherein the first light source module is configured to provide a first illumination beam, the second light source module is configured to provide a second illumination beam, the display beam of the electrically controllable viewing angle display unit comprises the first illumination beam or the second illumination beam in the narrow viewing angle mode, the display beam of the electrically controllable viewing angle display unit comprises the first illumination beam and the second illumination beam in the wide viewing angle mode.

7. A driving behavior warning method, wherein the driving behavior warning method comprises:
detecting behavior information of a driver; and
determining behavior posture of the driver based on the behavior information, the behavior posture comprising a normal behavior and an unconfirmed behavior, controlling a display mode of the electrically controllable viewing angle display unit according to a vehicle driving state and the behavior posture, the vehicle driving state comprising a moving state and a stationary state, wherein at least a portion of the electrically controllable viewing angle display unit is controlled to continuously switch between a narrow viewing angle mode and a wide viewing angle mode when the behavior posture is the unconfirmed behavior and the vehicle driving state is the moving state, wherein a light emitting viewing angle range of a display beam in the narrow viewing angle mode is smaller than a light emitting viewing angle range of the display beam in the wide viewing angle mode.

8. The driving behavior warning method according to claim 7, further comprising:
determining that the behavior posture of the driver is the unconfirmed behavior when the behavior information exhibits movement information greater than a specified range.

9. The driving behavior warning method according to claim 8, further comprising:
controlling the at least a portion of the electrically controllable viewing angle display unit to be in the wide viewing angle mode when it is determined that the behavior posture of the driver is the normal behavior and the vehicle driving state is the moving state.

10. The driving behavior warning method according to claim 7, wherein the electrically controllable viewing angle display unit comprises an electrically controlled viewing angle switching module, the electrically controllable viewing angle display unit comprises a first display region and a second display region, the first display region is closer to the driver than the second display region, and the at least a portion of the electrically controllable viewing angle display unit is located in the first display region, the at least a portion of the electrically controllable viewing angle display unit does not overlap the second display region, the electrically controlled viewing angle switching module reduces brightness of the display beam directed toward the driver in the narrow viewing angle mode.

11. The driving behavior warning method according to claim 7, wherein the electrically controllable viewing angle display unit comprises a first light source module and a second light source module, wherein the first light source module is configured to provide a first illumination beam, the second light source module is configured to provide a second illumination beam, the display beam of the electrically controllable viewing angle display unit comprises the first illumination beam or the second illumination beam in the narrow viewing angle mode, the display beam of the electrically controllable viewing angle display unit comprises the first illumination beam and the second illumination beam in the wide viewing angle mode.
